(19) United States
(12) Patent Application Publication
(10) Pub. No.: US 2026/0114607 A1
(43) Pub. Date: Apr. 30, 2026

(54) Transformable Whiteboard Desk Device

(71) Applicant: Mary Vail, Commerce City, CO (US)

(72) Inventor: Mary Vail, Commerce City, CO (US)

(21) Appl. No.: 19/248,881

(22) Filed: Jun. 25, 2025

Related U.S. Application Data
(60) Provisional application No. 63/711,201, filed on Oct. 24, 2024.

(51) Int. Cl. A47B 17/02; A47B 9/00; A47B 9/10; A47B 96/18; B43L 1/00

(52) U.S. Cl. CPC A47B 17/02; A47B 9/10; B43L 1/00; A47B 2009/003; A47B 96/18

(57) ABSTRACT

A transformable whiteboard desk device is provided. The device is comprised of a multifunctional workstation device comprised of a frame structure that supports both ergonomic and presentation functionalities through an adjustable and transformable body. The frame includes a lift system within each leg that enables vertical adjustment of the body via manual controls. The body is affixed to a tiltable platform that can transition from a flat desk configuration to a vertical whiteboard orientation, facilitated by user-operated tilt controls. The body is comprised of a top layer for standard desk tasks, a ferromagnetic middle layer for magnetic attachments, and a bottom dry-erase layer for vertical writing applications. The invention supports efficient transitions between individual work, collaborative tasks, and mobile presentations, reducing the need for separate furniture and maximizing functional use within constrained spaces.

### CROSS-REFERENCE TO RELATED APPLICATION

The present application claims priority to, and the benefit of, U.S. Provisional Application No. 63/711,201, which was filed on Oct. 24, 2024, and is incorporated herein by reference in its entirety.

### FIELD OF THE INVENTION

The present invention relates generally to the field of desks and whiteboards. More specifically, the present invention relates to a multifunctional workstation device comprised of a frame structure that supports both ergonomic and presentation functionalities through an adjustable and transformable body that can be used as a desk and a whiteboard. Accordingly, the present disclosure makes specific reference thereto. Nonetheless, it is to be appreciated that aspects of the present invention are also equally applicable to other like applications, devices, and methods of manufacture.

### BACKGROUND

Modern office environments, educational settings, and collaborative workspaces increasingly demand flexible and space-efficient furniture solutions. One persistent issue in these settings is the need to accommodate both a functional desk surface and a dry-erase board for collaborative ideation, note-taking, or instruction. Traditionally, these two items are separate and occupy significant floor space, contributing to overcrowded environments and limited mobility. At the same time, research indicates that prolonged sitting negatively impacts cognitive performance, physical health, and overall productivity. As a result, sit-stand desks have gained popularity due to their ergonomic benefits, enabling users to alternate between seated and upright positions. However, such desks typically serve a single purpose and lack integrated tools for communication and group engagement. The need to transition easily between individual-focused work and collaborative tasks remains unaddressed in many commercial and academic settings. Furthermore, while wall-mounted dry-erase boards are common, they are stationary and cannot be shared or repositioned easily in dynamic environments. These limitations highlight the growing requirement for multifunctional furniture capable of adapting to diverse user needs while optimizing available space.

Therefore, there exists a long-felt need in the art for a transformable whiteboard desk device that enables users to alternate between seated and standing positions for improved ergonomic posture. There also exists a long-felt need in the art for a transformable whiteboard desk device that combines a functional body with a vertically tiltable dry-erase panel for space-saving dual use. Moreover, there exists a long-felt need in the art for a transformable whiteboard desk device that facilitates collaboration, brainstorming, and visual presentation without the need for separate furniture components.

The subject matter disclosed and claimed herein, in one embodiment thereof, comprises a transformable whiteboard desk device. The device is comprised of a multifunctional workstation device comprised of a frame structure that supports both ergonomic and presentation functionalities through an adjustable and transformable body. The frame includes a lift system within each leg that enables vertical adjustment of the body via manual controls. The body is affixed to a tiltable platform that can transition from a flat desk configuration to a vertical whiteboard orientation, facilitated by user-operated tilt controls. The body is comprised of a dry-erase top layer and a ferromagnetic middle layer for magnetic attachments. The invention supports efficient transitions between individual work, collaborative tasks, and mobile presentations, reducing the need for separate furniture and maximizing functional use within constrained spaces.

In this manner, the transformable whiteboard desk device of the present invention accomplishes all the foregoing objectives and provides a tiltable desk that can rotate from a horizontal desk position to a vertical whiteboard orientation, thereby exposing a dry-erase surface and converting the desk into a presentation board. Additionally, the inclusion of a magnetic middle layer supports modular attachments and visual aids during collaborative sessions. The frame further allows deployment in a wide variety of environments while conserving space. Through this multifunctional design, the transformable whiteboard desk device supports productivity and creativity in a single, integrated solution.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a transformable whiteboard desk device. The device is comprised of a multifunctional workstation integrating ergonomic adjustability, presentation capability, and space-saving design for use in individual work, group collaboration, and mobile presentations.

The device is comprised of a frame comprising at least one leg, with a preferred configuration of two opposing legs for stability. A pneumatic lift system may be housed within each leg to enable vertical positioning of the body. The lift system may be selected from a range of actuation mechanisms, including gas cylinders, air springs, or electric actuators, based on application requirements. User-actuated manual controls are provided to operate the pneumatic lift system. These controls may be configured as levers, knobs, or pedals based on ergonomic design.

At least one valve assembly governs internal lift system operation, regulating gas distribution during height adjustments. Synchronized elevation of both legs may be achieved via a pneumatic manifold or a mechanical linkage system, enhancing balance and reducing torsional strain. A horizontal crossbar may be used to couple the legs, increasing rigidity and minimizing torsional deflection. The crossbar may also serve as a cable conduit.

The body is mounted to a tiltable platform located at the top of the frame. The platform is comprised of a hinge-based or gear-driven pivot mechanism enabling rotation from horizontal to vertical positions and beyond, allowing backward tilt or stowage. Tilting of the body is actuated by a user control, which may be implemented as a lever, crank, or push-button mechanism.

In the horizontal position, the top layer forms a usable desk surface made from a dry-erase material. A middle layer beneath the top layer is comprised of a ferromagnetic sheet, which enables attachment of magnetic accessories such as trays, clips, or printed materials. The dry-erase surface is compatible with alcohol-based markers and is treated with a stain-resistant, scratch-resistant, and durable coating. The magnetic layer supports various magnet types and maintains functionality at all tilt angles, enabling repositioning of magnetic accessories during use.

When tilted vertically, the body transforms into a whiteboard or display panel, exposing the dry-erase surface for use in presentations, teaching, or collaboration. This functionality eliminates the need for separate furnishings, enhancing spatial efficiency.

A method of use is also provided. The device is first assembled with a frame, at least one leg and foot member, and a body mounted to a tiltable platform. The body may be raised or lowered via manual controls operating the pneumatic lift system. The body may be used horizontally as a desk surface, then tilted to a vertical orientation using the tilt control, revealing the dry-erase surface and preserving magnetic attachment capability across all positions.

Accordingly, the transformable whiteboard desk device of the present invention is particularly advantageous as it provides a tiltable desk that can rotate from a horizontal desk position to a vertical whiteboard orientation, thereby exposing a dry-erase surface and converting the desk into a presentation board. Additionally, the inclusion of a magnetic middle layer supports modular attachments and visual aids during collaborative sessions. The frame further allows deployment in a wide variety of environments while conserving space. Through this multifunctional design, the transformable whiteboard desk device supports productivity and creativity in a single, integrated solution. In this manner, the transformable whiteboard desk device overcomes the limitations of existing desks and whiteboards known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a transformable whiteboard desk device of the present invention in the horizontal position in accordance with the disclosed architecture;

FIG. 2 illustrates a side view of one potential embodiment of a transformable whiteboard desk device of the present invention in the non-horizontal position in accordance with the disclosed architecture;

FIG. 3 illustrates a side cross-sectional view of a body of one potential embodiment of a transformable whiteboard desk device of the present invention in the horizontal position in accordance with the disclosed architecture; and

FIG. 4 illustrates a flowchart of a method of using one potential embodiment of a transformable whiteboard desk device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a transformable whiteboard desk device that enables users to alternate between seated and standing positions for improved ergonomic posture. There also exists a long-felt need in the art for a transformable whiteboard desk device that combines a functional body with a vertically tiltable dry-erase panel for space-saving dual use. Moreover, there exists a long-felt need in the art for a transformable whiteboard desk device that facilitates collaboration, brainstorming, and visual presentation without the need for separate furniture components.

The present invention, in one exemplary embodiment, is comprised of a transformable whiteboard desk device. The device is comprised of a multifunctional workstation incorporating ergonomic adjustability, presentation capability, and space-saving features suitable for individual work, group collaboration, and mobile presentations. The device is comprised of a frame including at least one leg, with a preferred arrangement of two opposing legs to provide enhanced stability. Each leg may house a pneumatic lift system to enable vertical adjustment of the body. The lift system may utilize various actuation mechanisms, including gas cylinders, air springs, or electric actuators, selected based on specific application needs. Manual user controls are provided to operate the lift system, and may be configured as levers, knobs, or pedals in accordance with ergonomic considerations.

At least one valve assembly regulates the internal operation of the lift system by controlling gas flow during height adjustments. Synchronized elevation between the legs may be achieved using a pneumatic manifold or mechanical linkage system, improving balance and reducing torsional strain. A horizontal crossbar may be included to couple the legs, increasing structural rigidity and resisting torsional deflection, while optionally serving as a cable conduit.

The body is mounted to a tiltable platform positioned at the top of the frame. The platform is comprised of a hinge-based or gear-driven pivot mechanism that permits rotation from a horizontal to a vertical orientation and beyond, enabling backward tilt or stowage. Tilting of the body is controlled by a user-operated mechanism, which may take the form of a lever, crank, or push-button control.

In the horizontal orientation, the top layer functions as a work surface preferably made from a dry-erase material. A ferromagnetic middle layer beneath the top layer allows attachment of magnetic accessories such as trays, clips, or printed items. The dry-erase surface is compatible with alcohol-based markers and is treated with a durable, stain-resistant, and scratch-resistant coating. The magnetic middle layer supports a variety of magnet types and retains functionality across all tilt angles, allowing dynamic repositioning of accessories.

When tilted to a vertical position, the body functions as a whiteboard or display panel, revealing the dry-erase surface for use in collaborative tasks, presentations, or teaching. This configuration removes the need for separate furnishings, thereby improving space efficiency.

A method of use is also disclosed. The device is initially assembled with a frame, at least one leg and foot member, and a body mounted on a tiltable platform. The pneumatic lift system is adjusted using manual controls to raise or lower the body. The horizontal position of the body serves as a desk surface, and the body may then be tilted to a vertical position using the tilt control to reveal the dry-erase surface while retaining magnetic compatibility across all orientations.

As a result, the transformable whiteboard desk device provides distinct advantages by allowing the body to rotate from a horizontal desk configuration to a vertical whiteboard orientation, thereby exposing the integrated dry-erase surface for presentation use. The magnetic middle layer further supports the use of modular accessories and visual aids during collaborative activities. The frame structure enables deployment across diverse environments while conserving space. Through this integrated multifunctional design, the transformable whiteboard desk device enhances productivity and creativity, addressing limitations found in conventional desk and whiteboard solutions.

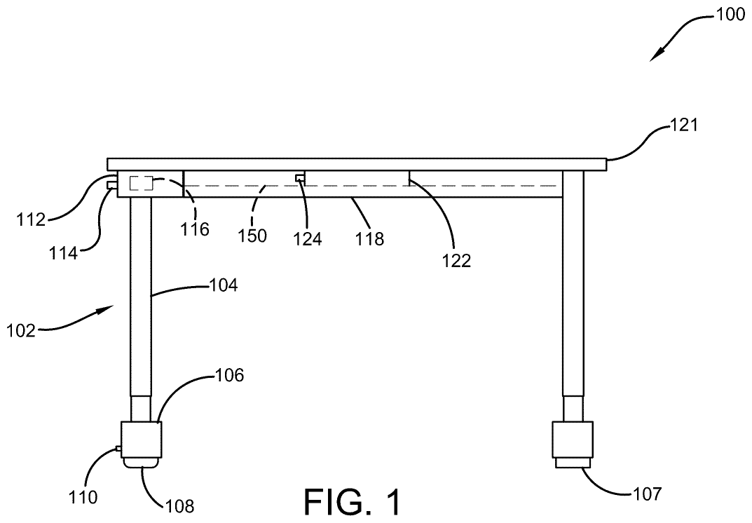

Referring initially to the drawings, FIG. 1 illustrates a side view of one potential embodiment of a transformable whiteboard desk device 100 of the present invention in the horizontal position in accordance with the disclosed architecture. The device 100 is comprised of a multifunctional workstation designed to integrate ergonomic flexibility, presentation functionality, and space-saving features into a unified structure suitable for individual work, collaborative engagement, and mobile presentations.

The device 100 is comprised of a frame 102. The frame 102 is comprised of at least one leg 104, and preferably a pair of opposing legs 104 positioned at either end of the frame 102 for enhanced balance. Each leg 104 may be further comprised of at least one foot member 106. Each foot member 106 is preferably oriented parallel to the ground and extends in both the anterior and posterior directions to provide longitudinal stability. Lateral extensions of the foot member 106 contribute to anti-tip performance. In one embodiment, the foot member 106 is comprised of a non-slip rubberized base 107.

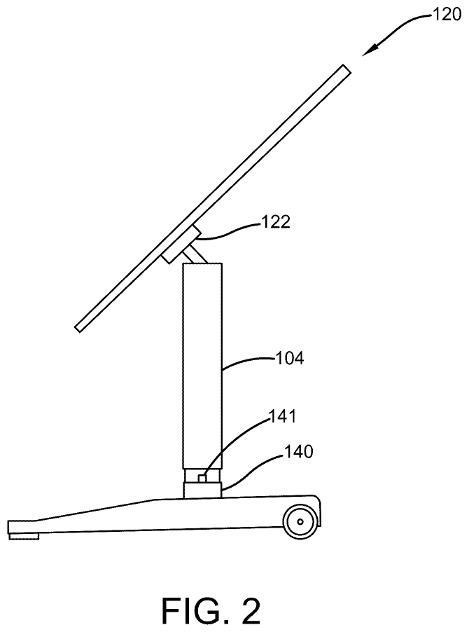

Each foot member 106 may be attached to the leg 104 via at least one pivot point 140 in one embodiment, as seen in FIG. 2. The pivot point 140 may be comprised of a mechanical hinge, rotary shaft joint, dual-axis gimbal joint, etc., allowing each foot member 106 to rotate along at least one axis relative to the leg 104. In one variation, the pivot point 140 may be lockable via a locking mechanism 141 such as, but not limited to, a detent pin to secure the foot in a deployed or stowed configuration.

Each foot member 106 may be further comprised of at least one wheel 108 positioned beneath the foot structure to enable mobility, in one embodiment. The wheel 108 may be a fixed-direction wheel, a swivel caster, an omnidirectional caster, etc., allowing movement in multiple planes. Each wheel 108 may be equipped with a locking mechanism 110. The locking mechanism 110 may be, but is not limited to, a foot-actuated lever brake, a push-to-lock toggle, etc.

Vertical positioning of the body 120 is enabled by a pneumatic lift system 112 housed within each leg 104. The pneumatic lift system 112 may be in the form of a gas-filled cylinder, an air spring mechanism, a bellows actuator, a hydraulic lift, a mechanical spring-based lift, an electric motor-driven linear actuator, etc. Each type may be selected based on application-specific requirements for smoothness, load capacity, adjustability, and user control.

The pneumatic lift system 112 is actuated by user-accessible manual controls 114. The manual controls 114 may be comprised of lever arms, rotary knobs, foot pedals, etc., depending on the ergonomic layout of the device 100.

The internal operation of the pneumatic lift system 112 is governed by at least one valve assembly 116. The valve assembly 116 may be in the form of one or more flow control valves, check valves, pressure relief valves, or solenoid-actuated directional valves configured to regulate gas distribution during elevation changes. In one configuration, the lift system 112 may support synchronized actuation between the two legs 104 via a connecting member 150 such as, but not limited to, a pneumatic manifold or a mechanical linkage system such as, but not limited to, a torsion rod assembly, cable-and-pulley mechanism, rack-and-pinion system, or chain-and-sprocket linkage. These configurations are designed to maintain an even elevation of the body 120 during adjustment, reducing racking forces and improving operational stability.

The legs 104 may be mechanically coupled via a horizontal crossbar 118 to increase rigidity and resist torsional deflection. In some configurations, the crossbar 118 may double as a cable conduit.

The body 120 is secured to a tiltable platform 122 located at the upper portion of the frame 102. The tiltable platform 122 is comprised of a hinge-based mount or a gear-driven pivot axis, enabling the body 120 to rotate from a 0-degree horizontal position to a 90-degree vertical position. In certain embodiments, the platform 122 may rotate beyond 90 degrees to enable backward tilt or stowage.

Tilting of the body 120 is regulated by a user-actuated control 124. The control 124 may be configured as a spring-loaded lever, rotary crank, push-button mechanism, etc.

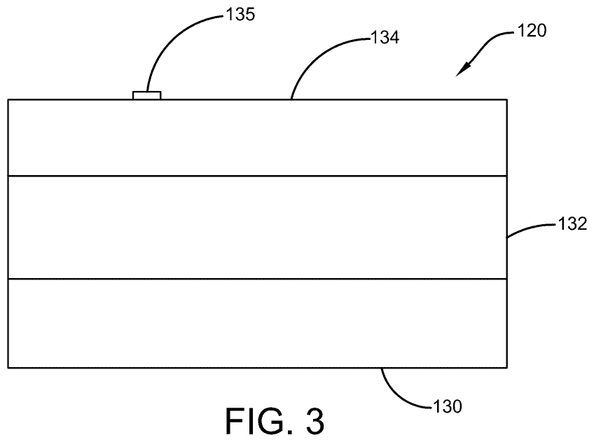

In one embodiment, the body 120 is comprised of a laminated composite panel preferably comprised of three distinct layers, as seen in FIG. 3. In the horizontal position, the device 100 operates as a standard desk, with the top layer 134 forming the uppermost usable surface. The top layer 134 is comprised of materials commonly used in school or institutional desks, such as, but not limited to, high-density fiberboard (HDF), medium-density fiberboard (MDF), particle board, or plywood with a laminated finish. The upper surface of the top layer 134 may be covered with a protective coating 135 such as, but not limited to, high-pressure laminate (HPL), melamine resin sheet, or thermoplastic overlay to provide a smooth, durable, and stain-resistant working surface suitable for writing, reading, and general academic or office use.

Beneath the top layer 134, the body 120 includes a middle layer 132 comprised of a ferromagnetic sheet, such as, but not limited to, cold-rolled steel or a magnetically receptive alloy film. The magnetic properties of the middle layer 132 enable attachment of magnets for holding visual aids, printed materials, or magnetic accessories such as pen holders, trays, or clip modules.

The bottom layer 130, which is revealed when the body 120, is tilted into a vertical orientation, is comprised of a dry-erase writing surface manufactured from melamine-coated hardboard, high-pressure laminate (HPL), or PET film. The dry-erase layer 130 may be provided in a gloss finish for high visual contrast or a matte finish to minimize glare under ambient lighting. In one embodiment, the top layer 134 may be the same dry-erase surface as the bottom layer 130, wherein the bottom layer may be made of any material which may include but is not limited to high-density fiberboard (HDF), medium-density fiberboard (MDF), particle board, or plywood with a laminated finish, etc.

The dry-erase layer 130 is compatible with alcohol-based markers and includes a stain-resistant coating to prevent ghosting and ink residue accumulation. Surface durability is enhanced via a scratch-resistant film or UV-hardened resin coating.

The magnetic compatibility of the middle layer 132 supports various grades and sizes of magnets including neodymium, samarium cobalt, and ceramic-based types. The functionality is maintained across all tilt angles, enabling dynamic repositioning of content during presentations or collaborative sessions.

An edge 121 of the body 120 may be configured in multiple variations. In one variation, the edge 121 may be a beveled contour machined into the core material. In another variation, the edge 121 may be fitted with a soft-touch bumper 142 comprised of thermoplastic elastomer (TPE), silicone, or PVC foam. The bumper 142 may be interchangeable and may be color-coded for aesthetic or organizational purposes.

When tilted into a vertical or tilted orientation (i.e., not horizontal), as seen in FIG. 2, the body 120 transforms into a portable display board or vertical writing panel. This mode allows the integrated dry-erase surface 130 to serve as a whiteboard for teaching, brainstorming, and group discussions. The dry-erase panel becomes the active surface, while the previously top-facing desk surface is rotated away from the user. In compact environments such as classrooms, co-working spaces, or mobile offices, this transformable functionality eliminates the need for separate furniture, thereby improving spatial efficiency and promoting multifunctional use of a single footprint.

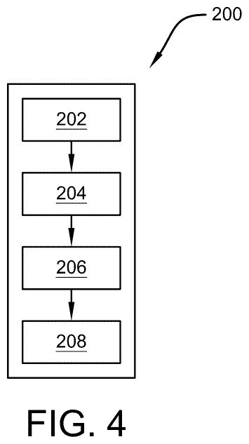

The present invention is also comprised of a method of using 200 the device 100, as seen in FIG. 4. First, a device 100 is provided comprised of a frame 102 comprised of at least one leg 104, at least one foot member 106, and at least one body 120 mounted to a tiltable platform 122 [Step 202]. Next, the pneumatic lift system 112 housed within each leg 104 can be actuated via manual controls 114 to raise or lower the body 120 to a desired height, with the internal valve assembly 116 and optional pneumatic manifold 150 or mechanical linkage 152 ensuring synchronized adjustment [Step 204]. Next, a user can utilize the horizontal orientation of the body 120 for standard desk activities such as writing or reading [Step 206]. Next, the body 120 can be tilted by actuating the control 124, causing the tiltable platform 122 to rotate the body 120 from a horizontal position to a vertical position such that the dry-erase surface 130 can be used as a whiteboard, while the middle layer 132 retains attached magnetic accessories across all angles [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “transformable whiteboard desk device” and “device” are interchangeable and refer to the transformable whiteboard desk device 100 of the present invention.

Notwithstanding the foregoing, the transformable whiteboard desk device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the transformable whiteboard desk device 100 as shown in the FIGS. are for illustrative purposes only, and that many other sizes and shapes of the transformable whiteboard desk device 100 are well within the scope of the present disclosure. Although the dimensions of the transformable whiteboard desk device 100 are important design parameters for user convenience, the transformable whiteboard desk device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A transformable whiteboard desk device comprising:
a frame comprised of a leg;
a foot member attached to the leg;
a pneumatic lift system actuated by a control, the pneumatic lift system configured to raise or lower a body secured to the frame;
a tiltable platform attached to the frame and configured to support the body, wherein the tiltable platform enables rotation of the body between a horizontal position and a vertical position; and
wherein the body is comprised of a top layer comprised of a dry-erase surface and a middle layer comprised of a magnetic material.

2. The transformable whiteboard desk device of claim 1, wherein the pneumatic lift system is comprised of a gas-filled cylinder.

3. The transformable whiteboard desk device of claim 1, wherein the body is secured to the tiltable platform via a hinge.

4. The transformable whiteboard desk device of claim 1, wherein the dry-erase writing surface is comprised of a melamine-coated hardboard.

5. The transformable whiteboard desk device of claim 1, wherein the foot member is comprised of a non-slip rubberized base.

6. The transformable whiteboard desk device of claim 1, wherein the foot member is attached to the leg via a pivot point.

7. The transformable whiteboard desk device of claim 6, wherein the pivot point is comprised of a hinge, a rotary shaft joint, or a gimbal joint.

8. The transformable whiteboard desk device of claim 6, wherein the pivot point is comprised of a locking member.

9. The transformable whiteboard desk device of claim 1, wherein the pneumatic lift system is comprised of a valve assembly.

10. The transformable whiteboard desk device of claim 9, wherein the valve assembly is comprised of a solenoid-actuated directional valve.

11. A transformable whiteboard desk device comprising:
a frame comprised of a leg;
a foot member attached to the leg, the foot member comprised of a wheel;
a pneumatic lift system actuated by a control, the pneumatic lift system configured to raise or lower a body secured to the frame; and
a tiltable platform attached to the frame and configured to support the body, wherein the tiltable platform enables rotation of the body between a horizontal position and a vertical position, and further wherein the body is comprised of a top layer comprised of a dry-erase writing surface and a middle layer comprised of a ferromagnetic sheet.

12. The transformable whiteboard desk device of claim 11, wherein the wheel is comprised of a locking mechanism.

13. The transformable whiteboard desk device of claim 11, wherein the pneumatic lift system is comprised of a valve assembly.

14. The transformable whiteboard desk device of claim 13, wherein the valve assembly is comprised of a flow control valve.

15. The transformable whiteboard desk device of claim 11, wherein the top layer is comprised of a protective coating.

16. The transformable whiteboard desk device of claim 11, wherein the pneumatic lift system is comprised of a gas-filled cylinder.

17. The transformable whiteboard desk device of claim 11, wherein the body is secured to the tiltable platform via a hinge.

18. The transformable whiteboard desk device of claim 11, wherein the pneumatic lift system is comprised of a valve assembly.

19. The transformable whiteboard desk device of claim 18, wherein the valve assembly is comprised of a solenoid-actuated directional valve.

20. A method of using a transformable whiteboard desk device, the method comprising:
providing a transformable whiteboard desk device comprised of a frame comprised of a leg, and a body mounted to a tiltable platform attached to the frame;
actuating a pneumatic lift system via a control to raise or lower the body;
utilizing a horizontal position of the body for a desk surface; and
tilting the body by actuating a control to rotate the tiltable platform such that the body transitions from the horizontal position to a vertical position, exposing a dry-erase surface.
